(19) United States
(12) Patent Application Publication
(10) Pub. No.: US 2025/0263583 A1
(43) Pub. Date: Aug. 21, 2025

(54) MOLYBDENUM POLISHING COMPOSITION

(71) Applicant: FUJIMI INCORPORATED, Kiyosu-shi (JP)

(72) Inventors: Christopher NEWMAN, Tualatin, OR (US); Glenn WHITENER, Tualatin, OR (US)

(73) Assignee: FUJIMI INCORPORATED, Kiyosu-shi (JP)

(21) Appl. No.: 19/051,518

(22) Filed: Feb. 12, 2025

Related U.S. Application Data
(60) Provisional application No. 63/554,708, filed on Feb. 16, 2024.

(51) Int. Cl. C09G 1/02; C23F 1/26

(52) U.S. Cl. CPC C09G 1/02; C23F 1/26

(57) ABSTRACT

To provide compositions and methods of polishing molybdenum surfaces that have a high removal rate and low static etch rate for molybdenum. Provided is a polishing composition, comprising: an abrasive, an oxidizer containing halogen oxoacids or salts thereof, a first inhibitor comprising a diamine, and a second inhibitor comprising a triamine.

### BACKGROUND OF THE INVENTION

### Field of the Invention

### Description of the Related Art

The following description of the background of the present technology is provided simply as an aid in understanding the present technology and is not admitted to describe or constitute prior art to the present technology.

Molybdenum metal is finding increased use in applications for microelectronic devices, including use in low-resistivity interconnects, particularly with nanoscale dimensions (e.g., thicknesses under 50 nm). However, current compositions and methods for polishing molybdenum surfaces suffer from low removal rate, high static etch rate, or high surface roughness for the polished molybdenum. Thus, there is a growing need for compositions and methods of polishing molybdenum surfaces that have a high removal rate and low static etch rate for molybdenum. It is against this backdrop that the compositions and methods of the present disclosure were developed.

### SUMMARY OF THE INVENTION

In some embodiments, the present disclosure relates to a polishing composition comprising: an abrasive; an oxidizer comprising halogen oxoacids or salts thereof; a first inhibitor comprising a diamine; and a second inhibitor comprising a triamine, wherein the pH of the composition is from 1.5 to 5. The “polishing composition” as used herein may be referred to merely as a “composition”. The expression “X to Y” is used as an expression that means a range including the numerical values described on both sides of the “to” (X and Y) as the lower limit and the upper limit, respectively, and means that “X or more and Y or less”. The description of a plurality of the expressions “X to Y”, for example, the description “X1 to Y1, or X2 to Y2”, discloses all of the ranges including the numerical values as the upper limits, the ranges including the numerical values as the lower limits, and the combinations of the upper limits and the lower limits (that is, the description provides a legal basis for correction). Specifically, all of the correction to a value greater than or equal to X1, the correction to a value less than or equal to Y2, the correction to a value less than or equal to X1, the correction to a value greater than or equal to Y2, the correction to a value of X1 to X2, and the correction to a value of X1 to Y2 should be regarded as legal. Since the description “greater than or equal to X” means that the value is X or greater than X, the description inclusively means “greater than X”. Since the description “less than or equal to Y” means that the value is Y or less than Y, the description inclusively means “less than Y” similarly. Operation and the measurement of physical properties are performed under the conditions of room temperature (20 to 25° C.)/a relative humidity of 40 to 50% RH unless otherwise specified. Concentration described herein may be concentration at a POU (point of use) or concentration before dilution to the POU concentration. The dilution factor may be 2 to 10. It should be understood that the present application discloses the combinations of all the embodiments and descriptions disclosed herein. That is, it should be understood that the combinations can provide bases for correction. If the content or the concentration of a solution containing two or more components is described, the content or the concentration can be the total amount thereof.

In some embodiments, the oxidizer comprises iodic acid, periodic acid, or a salt thereof. In some embodiments, the oxidizer comprises iodic acid or a salt thereof. In some embodiments, the oxidizer comprises periodic acid (e.g., orthoperiodic acid (H₅IO₆), metaperiodic acid (HIO₄), or a combination thereof), iodic acid (HIO₃), sodium iodate (NaIO₃), potassium iodate (KIO₃), or a combination thereof. In some embodiments, the oxidizer comprises potassium iodate (KIO₃).

In some embodiments, the abrasive comprises colloidal silica. In some embodiments, the abrasive has a primary particle size of 5 nm to 15 nm. In some embodiments, the abrasive has a zeta potential of less than 6 mV in the composition.

In some embodiments, the first inhibitor is a diamine. In some embodiments, the first inhibitor is a triamine.

In some embodiments, the first inhibitor comprises a polyether diamine. In some embodiments, the first inhibitor comprises polyoxyethylene ether diamine. In some embodiments, the first inhibitor comprises 3,6-dioxaoctamethylenediamine.

In some embodiments, the second inhibitor comprises a polyether triamine comprising ethylene oxide groups, propylene oxide groups, or a combination thereof. In some embodiments, the second inhibitor comprises an amine-terminated trimethylolpropane tris [poly (propylene glycol)] ether. In some embodiments, the second inhibitor has an average molecular weight of 300 to 500.

In some embodiments, the first inhibitor is present in the composition at a concentration of 0.05 wt. % to 5 wt. %, relative to the total weight of the composition. In some embodiments, the second inhibitor is present in the composition at a concentration of 0.01 wt. % to 0.1 wt. %, relative to the total weight of the composition. In some embodiments, the first inhibitor and the second inhibitor are present in the composition at a weight ratio (first inhibitor to second inhibitor) of 2:1 to 10:1.

In some embodiments, the oxidizer is present in the composition at a concentration of 0.1 wt. % to 2 wt. %, relative to the total weight of the composition.

In some embodiments, the abrasive is present in the composition at a concentration of 0.05 wt. % to 5 wt. %, relative to the total weight of the composition.

In some embodiments, the polishing composition achieves a Mo removal rate (Mo RR) of greater than or equal to 1,000 Å/min. In some embodiments, the polishing composition achieves a Mo static etch rate (Mo SER) at 50° C. of less than 200 Å/min. In some embodiments, the polishing composition achieves a value of greater than or equal to 2, the value being calculated by dividing the Mo removal rate by the Mo static etch rate at 50° C. (Mo RR/SER selectivity).

In another aspect, which may be combined with any other aspect or embodiment, the present disclosure relates to a method for polishing an object comprising a Mo surface, the method comprising: contacting the Mo surface with the polishing composition of any of the embodiments disclosed herein using a polishing pad; and moving the polishing pad relative to the Mo surface while the polishing composition is in contact with the Mo surface to abrade the Mo surface.

In some embodiments, the polishing achieves a Mo removal rate (Mo RR) of greater than or equal to 1,000 Å/min. In some embodiments, the polishing achieves a Mo static etch rate (Mo SER) at 50° C. of less than 200 Å/min. In some embodiments, the polishing achieves a Mo RR/SER selectivity of greater than or equal to 2.

The present invention also includes the following aspects or forms.

1. A polishing composition, comprising: an abrasive; an oxidizer containing halogen oxoacids or salts thereof; a first inhibitor comprising a diamine; and a second inhibitor comprising a triamine.

2. The polishing composition of item 1, wherein the pH is from 1.5 to 5.

3. The polishing composition of item 2, wherein the pH is less than 4.

4. The polishing composition of any of claims 1 to 3, wherein the diamine is represented by the formula H₂N-(AO)ₓ-A-NH₂ wherein A are each independently a divalent alkylene group having 1 to 4 carbon atoms, and x is greater than or equal to 1 and less than or equal to 50.

5. The polishing composition of item 4, wherein A is a methylene group or a propylene group.

6. The polishing composition of item 4, wherein the diamine comprises a diamine having a structure corresponding to Formula I:

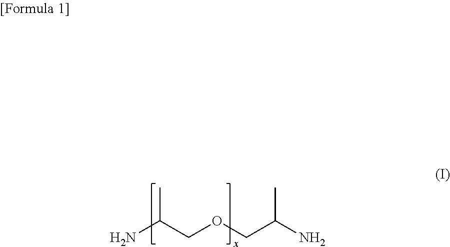

wherein x is an integer between 2 and 50.

7. The polishing composition of item 4, wherein the diamine comprises a diamine corresponding to a structure of the following Formula II:

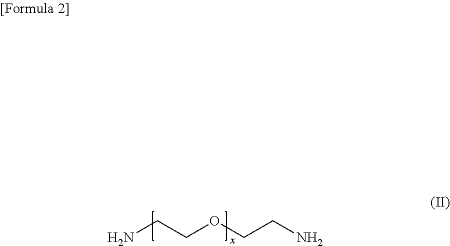

wherein x is an integer between 2 and 50.

8. The polishing composition of any of items 1 to 3, wherein the triamine is represented by the formula C{—R}{—R¹(OA)^{x}-NH₂}{—R²(OA)_{y}-NH₂}{—R³(OA)_{z}-NH₂}, wherein A are each independently a divalent alkylene group having 1 to 4 carbon atoms, R is a hydrogen atom or an alkyl group having 1 to 4 carbon atoms, R¹ to R³ are each independently an alkylene group having 1 to 4 carbon atoms, x, y, and z are each independently 1 to 30, and the sum of x, y, and z is 3 to 90.

9. The polishing composition of item 8, wherein A is a methylene group or a propylene group, R is an alkyl group having 1 to 3 carbon atoms, and R¹ to R³ are each independently an alkylene group having 1 to 3 carbon atoms.

10. The polishing composition of item 8, wherein the triamine comprises a triamine having a structure corresponding to a structure of the following Formula III:

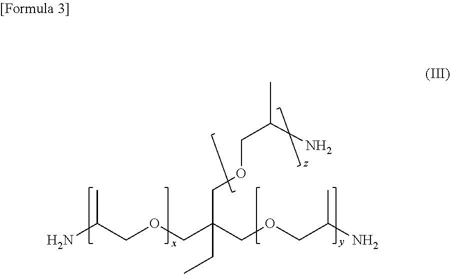

wherein x, y, and z are each independently an integer between 1 and 20, and the average of (x+y+z) in the triamine inhibitor is 3 to 30 (e.g., about 5.3 or about 11.3).

11. The polishing composition of any of items 1 to 10, wherein the oxidizer comprises iodic acid or a salt thereof.

12. The polishing composition of any of items 1 to 11, wherein the first inhibitor has a molecular weight of 100 to 300, and the second inhibitor has a molecular weight of 300 to 500.

13. The polishing composition of any of items 1 to 12, wherein a ratio of a weight of the diamine to a weight of the triamine is greater than or equal to 1.5.

14. The polishing composition of any of items 1 to 13, wherein the polishing composition achieves:
i) a Mo static etch rate (SER) at 50° C. of less than or equal to 250 Å/min, and
ii) a Mo removal rate (Mo RR) of greater than or equal to 1,600 Å/min, or a Mo removal rate (Mo RR) of greater than or equal to 1,000 Å/min and a Mo RR/SER selectivity of greater than or equal to 10.

Reference will now be made in detail to some specific embodiments contemplated by the present disclosure. While various embodiments are described herein, it will be understood that it is not intended to limit the present technology to the described embodiments. On the contrary, it is intended to cover alternatives, modifications, and equivalents as may be included within the spirit and scope of the technology as defined by the appended claims.

### DETAILED DESCRIPTION

### Polishing Compositions

In some embodiments, the present disclosure relates to polishing compositions for polishing Mo surfaces, the polishing compositions comprising: an abrasive; an oxidizer comprising halogen oxoacids or salts thereof; a first inhibitor comprising a diamine; and a second inhibitor comprising a triamine, wherein the pH of the composition is from 1.5 to 5. A surface including the surface of material other than molybdenum (Mo) may be polished with the polishing compositions according to the present disclosure.

### Abrasive (Abrasive Particles)

Polishing compositions according to the present disclosure comprise abrasive particles suitable for polishing a surface comprising molybdenum (Mo). In some embodiments, the abrasive particles comprise one or more metal oxide particles (e.g., zirconia, hafnia, alumina, titania, silica, ceria, and any combination thereof). In some embodiments, the abrasive particles comprise silica at greater than or equal to 80 wt. %, greater than or equal to 85 wt. %, greater than or equal to 90 wt. %, greater than or equal to 95 wt. %, or greater than or equal to 95 wt. %. In some embodiments, the abrasive particles comprise colloidal silica. In some embodiments, the abrasive particles comprise colloidal silica at greater than or equal to 80 wt. %, greater than or equal to 85 wt. %, greater than or equal to 90 wt. %, greater than or equal to 95 wt. %, or greater than or equal to 95 wt. %. In addition, the abrasive particles may be a commercial product, synthetic product, or any combination thereof. In some embodiments, the abrasive particles are anionic. Within the context of this application, “anionic” particles have a negative surface charge or zeta potential charge at the pH of the polishing composition. In some embodiments, the abrasive particles are cationic. Within the context of this application, “cationic” particles have a positive surface charge or zeta potential charge at the pH of the polishing composition.

In some embodiments, the abrasive particles are unmodified (i.e., do not have a chemical species attached to the particle surface). Examples of the chemical species include the following. In some embodiments, the abrasive particles are surface-modified by a chemical species covalently attached to the particle surface and having a terminal anionic group or cationic group. In some embodiments, the abrasive particles comprise colloidal particles which are anionically modified, e.g., by immobilization of an organic acid on the colloidal particle surface. Examples of the organic acid as the chemical species include sulfonic acids and carboxylic acids.

In some embodiments, immobilization of an organic acid on the surface of the abrasive particles (e.g., colloidal silica) in the polishing composition may be carried out by chemically bonding a functional group of the organic acid to the surface of the abrasive particle (e.g., colloidal silica). The immobilization of an organic acid on colloidal silica cannot be achieved by only allowing colloidal silica and an organic acid to merely coexist. The immobilization of an organic acid (e.g., a sulfonic acid), on colloidal silica can be carried out, for example, by a method described in E. Cano-Serrano et al., Sulfonic Acid-Functionalized Silica Through Quantitative Oxidation of Thiol Groups, Chem. Commun. 246-47 (2003), which is hereby incorporated by reference in its entirety. Specifically, colloidal silica with a sulfonic acid immobilized on its surface can be obtained by coupling a silane coupling agent having a thiol group, such as 3-mercaptopropyl trimethoxysilane (“MPS”), to colloidal silica, followed by oxidizing the thiol group with hydrogen peroxide to form a surface-immobilized sulfonic acid (e.g., a surface-bound propane sulfonic acid, such as oxidized MPS).

The immobilization of a carboxylic acid on colloidal silica can be carried out, for example, by a method described in Y. Kazuo et al., Novel Silane Coupling Agents Containing a Photolabile 2-Nitrobenzyl Ester for Introduction of a Carboxy Group on the Surface of Silica Gel, 3 Chem. Lett. 228-29 (2000), which is hereby incorporated by reference in its entirety. Specifically, colloidal silica in which a carboxylic acid is immobilized on its surface can be obtained by coupling a silane coupling agent including photoreactive 2-nitrobenzyl ester to colloidal silica, followed by photoirradiation. These examples of organic acid immobilization on colloidal silica are intended to be exemplary and are not intended to be limiting. Other organic immobilization techniques using different organic acids and different abrasive particle materials (e.g., other than colloidal silica) are intended to be encompassed within the scope of the present disclosure.

The abrasive particles may have any suitable average primary particle diameter to achieve efficient polishing (high removal rate) while achieving a high-quality surface (e.g., reduced surface defects, such as scratches). In some embodiments, the abrasive particles have an average primary particle diameter of greater than or equal to about 2 nm, greater than or equal to about 3 nm, greater than or equal to about 4 nm, greater than or equal to about 5 nm, greater than or equal to about 6 nm, greater than or equal to about 7 nm, greater than or equal to about 8 nm, greater than or equal to about 9 nm, greater than or equal to about 10 nm, greater than or equal to about 11 nm, greater than or equal to about 12 nm, greater than or equal to about 13 nm, greater than or equal to about 14 nm, greater than or equal to about 15 nm, greater than or equal to about 16 nm, greater than or equal to about 17 nm, greater than or equal to about 18 nm, greater than or equal to about 19 nm, greater than or equal to about 20 nm, greater than or equal to about 21 nm, greater than or equal to about 22 nm, greater than or equal to about 23 nm, greater than or equal to about 24 nm, greater than or equal to about 25 nm, greater than or equal to about 30 nm, greater than or equal to about 35 nm, greater than or equal to about 40 nm, greater than or equal to about 45 nm, greater than or equal to about 50 nm, greater than or equal to about 55 nm, greater than or equal to about 60 nm, greater than or equal to about 65 nm, greater than or equal to about 70 nm, greater than or equal to about 75 nm, greater than or equal to about 80 nm, or any range or value therein between. The average primary particle diameter may be measured using any suitable method known in the art (e.g., transmission electron microscopy, scanning electron microscopy, or by STEM, such as by using a Hitachi High-Tech HD-2700 Scanning Transmission Electron Microscope). The expression “about X” (X is a numerical value) as used herein can mean that the expression further includes ±10% or ±5% of X, and means X×0.9 to X×1.1 in the case of ±10%, for example. The expression “about X” may be X itself.

In some embodiments, the abrasive particles have an average primary particle diameter of less than or equal to about 100 nm, less than or equal to about 95 nm, less than or equal to about 90 nm, less than or equal to about 85 nm, less than or equal to about 80 nm, less than or equal to about 75 nm, less than or equal to about 70 nm, less than or equal to about 65 nm, less than or equal to about 60 nm, less than or equal to about 55 nm, less than or equal to about 50 nm, less than or equal to about 45 nm, less than or equal to about 40 nm, less than or equal to about 35 nm, less than or equal to about 30 nm, less than or equal to about 25 nm, less than or equal to about 24 nm, less than or equal to about 23 nm, less than or equal to about 22 nm, less than or equal to about 21 nm, less than or equal to about 20 nm, less than or equal to about 19 nm, less than or equal to about 18 nm, less than or equal to about 17 nm, less than or equal to about 16 nm, less than or equal to about 15 nm, less than or equal to about 14 nm, less than or equal to about 13 nm, less than or equal to about 12 nm, less than or equal to about 11 nm, less than or equal to about 10 nm, or any range or value therein between.

In some embodiments, the abrasive particles have an average primary particle diameter of about 5 nm to about 100 nm, about 5 nm to about 90 nm, about 5 nm to about 80 nm, about 5 nm to about 70 nm, about 5 nm to about 60 nm, about 5 nm to about 50 nm, about 5 nm to about 45 nm, about 5 nm to about 40 nm, about 5 nm to about 35 nm, about 5 nm to about 30 nm, about 5 nm to about 25 nm, about 5 nm to about 20 nm, about 5 nm to about 15 nm, about 10 nm to about 100 nm, about 10 nm to about 90 nm, about 10 nm to about 80 nm, about 10 nm to about 70 nm, about 10 nm to about 60 nm, about 10 nm to about 50 nm, about 10 nm to about 45 nm, about 10 nm to about 40 nm, about 10 nm to about 35 nm, about 10 nm to about 30 nm, about 10 nm to about 25 nm, about 10 nm to about 20 nm, about 10 nm to about 15 nm, about 20 nm to about 100 nm, about 20 nm to about 90 nm, about 20 nm to about 80 nm, about 20 nm to about 70 nm, about 20 nm to about 60 nm, about 20 nm to about 50 nm, about 20 nm to about 45 nm, about 20 nm to about 40 nm, or any range or value therein.

In several embodiments, the abrasive particles have an average secondary particle size of greater than or equal to about 10 nm, greater than or equal to about 15 nm, greater than or equal to about 16 nm, greater than or equal to about 17 nm, greater than or equal to about 18 nm, greater than or equal to about 19 nm, greater than or equal to about 20 nm, greater than or equal to about 21 nm, greater than or equal to about 22 nm, greater than or equal to about 23 nm, greater than or equal to about 24 nm, greater than or equal to about 25 nm, greater than or equal to about 30 nm, or any range or value therein between. The average secondary particle size may be measured using any suitable method known in the art (e.g., by light scattering using Zetasizer Nano ZS, which is available from Malvern Panalytical Ltd.).

In several embodiments, the abrasive particles have an average secondary particle size of less than or equal to about 150 nm, less than or equal to about 140 nm, less than or equal to about 135 nm, less than or equal to about 130 nm, less than or equal to about 120 nm, less than or equal to about 110 nm, less than or equal to about 100 nm, less than or equal to about 95 nm, less than or equal to about 90 nm, less than or equal to about 85 nm, less than or equal to about 80 nm, less than or equal to about 75 nm, less than or equal to about 70 nm, less than or equal to about 65 nm, less than or equal to about 60 nm, less than or equal to about 55 nm, less than or equal to about 50 nm, less than or equal to about 45 nm, less than or equal to about 40 nm, less than or equal to about 35 nm, less than or equal to about 30 nm, or any range or value therein between.

In several embodiments, the abrasive particles have an average particle size of about 10 nm to about 150 nm, about 10 nm to about 135 nm, about 10 nm to about 100 nm, about 10 nm to about 90 nm, about 10 nm to about 80 nm, about 10 nm to about 70 nm, about 10 nm to about 60 nm, about 10 nm to about 50 nm, about 10 nm to about 45 nm, about 10 nm to about 40 nm, about 10 nm to about 35 nm, about 20 nm to about 150 nm, about 20 nm to about 135 nm, about 20 nm to about 100 nm, about 20 nm to about 90 nm, about 20 nm to about 80 nm, about 20 nm to about 70 nm, about 20 nm to about 60 nm, about 20 nm to about 50 nm, about 20 nm to about 45 nm, about 20 nm to about 40 nm, about 20 nm to about 35 nm, about 20 nm to about 30 nm, or any range or value therein. In several embodiments, the abrasive particles have an average secondary particle size of about 24 nm to about 64 nm, or any range or value therein.

In some embodiments, the abrasive particles are present in the composition at a concentration by weight, relative to the total weight of the composition, of greater than or equal to about 0.01 wt. %, greater than or equal to about 0.03 wt. %, greater than or equal to about 0.05 wt. %, greater than or equal to about 0.07 wt. %, greater than or equal to about 0.1 wt. %, greater than or equal to about 0.15 wt. %, greater than or equal to about 0.2 wt. %, greater than or equal to about 0.25 wt. %, greater than or equal to about 0.3 wt. %, greater than or equal to about 0.35 wt. %, greater than or equal to about 0.4 wt. %, greater than or equal to about 0.45 wt. %, greater than or equal to about 0.5 wt. %, greater than or equal to about 0.55 wt. %, greater than or equal to about 0.60 wt. %, greater than or equal to about 0.65 wt. %, greater than or equal to about 0.7 wt. %, greater than or equal to about 0.75 wt. %, greater than or equal to about 0.8 wt. %, greater than or equal to about 0.85 wt. %, greater than or equal to about 0.9 wt. %, greater than or equal to about 0.95 wt. %, greater than or equal to about 1.0 wt. %, greater than or equal to about 1.1 wt. %, greater than or equal to about 1.2 wt. %, greater than or equal to about 1.3 wt. %, greater than or equal to about 1.4 wt. %, greater than or equal to about 1.5 wt. %, greater than or equal to about 1.6 wt. %, greater than or equal to about 1.7 wt. %, greater than or equal to about 1.8 wt. %, greater than or equal to about 1.9 wt. %, greater than or equal to about 2.0 wt. %, greater than or equal to about 2.5 wt. %, greater than or equal to about 3.0 wt. %, greater than or equal to about 3.5 wt. %, greater than or equal to about 4.0 wt. %, greater than or equal to about 4.5 wt. %, greater than or equal to about 5.0 wt. %, greater than or equal to about 5.5 wt. %, greater than or equal to about 6.0 wt. %, greater than or equal to about 6.5 wt. %, greater than or equal to about 7.0 wt. %, greater than or equal to about 7.5 wt. %, greater than or equal to about 8.0 wt. %, greater than or equal to about 8.5 wt. %, greater than or equal to about 9.0 wt. %, greater than or equal to about 9.5 wt. %, greater than or equal to about 10.0 wt. %, or any range or value therein between.

In some embodiments, the abrasive particles are present in the composition at a concentration by weight, relative to the total weight of the composition, of less than or equal to about 10.0 wt. %, less than or equal to about 9.5 wt. %, less than or equal to about 9.0 wt. %, less than or equal to about 8.5 wt. %, less than or equal to about 8.0 wt. %, less than or equal to about 7.5 wt. %, less than or equal to about 7.0 wt. %, less than or equal to about 6.5 wt. %, less than or equal to about 6.0 wt. %, less than or equal to about 5.5 wt. %, less than or equal to about 5.0 wt. %, less than or equal to about 4.5 wt. %, less than or equal to about 4.0 wt. %, less than or equal to about 3.5 wt. %, less than or equal to about 3.0 wt. %, less than or equal to about 2.5 wt. %, less than or equal to about 2.0 wt. %, less than or equal to about 1.9 wt. %, less than or equal to about 1.8 wt. %, less than or equal to about 1.7 wt. %, less than or equal to about 1.6 wt. %, less than or equal to about 1.5 wt. %, less than or equal to about 1.4 wt. %, less than or equal to about 1.3 wt. %, less than or equal to about 1.2 wt. %, less than or equal to about 1.1 wt. %, less than or equal to about 1.0 wt. %, less than or equal to about 0.95 wt. %, less than or equal to about 0.9 wt. %, less than or equal to about 0.85 wt. %, less than or equal to about 0.8 wt. %, less than or equal to about 0.75 wt. %, less than or equal to about 0.7 wt. %, less than or equal to about 0.65 wt. %, less than or equal to about 0.6 wt. %, less than or equal to about 0.55 wt. %, less than or equal to about 0.5 wt. %, less than or equal to about 0.45 wt. %, less than or equal to about 0.4 wt. %, less than or equal to about 0.35 wt. %, less than or equal to about 0.3 wt. %, less than or equal to about 0.25 wt. %, less than or equal to about 0.2 wt. %, less than or equal to about 0.15 wt. %, less than or equal to about 0.1 wt. %, or any range or value therein between.

In some embodiments, the abrasive particles are present in the composition at a concentration by weight, relative to the total weight of the composition, of about 0.05 wt. % to about 10.0 wt. %, about 0.07 wt. % to about 10.0 wt. %, about 0.1 wt. % to about 10.0 wt. %, about 0.2 wt. % to about 10.0 wt. %, about 0.3 wt. % to about 10.0 wt. %, about 0.4 wt. % to about 10.0 wt. %, about 0.5 wt. % to about 10.0 wt. %, about 0.6 wt. % to about 10.0 wt. %, about 0.7 wt. % to about 10.0 wt. %, about 0.8 wt. % to about 10.0 wt. %, about 0.9 wt. % to about 10.0 wt. %, about 1.0 wt. % to about 10.0 wt. %, about 0.05 wt. % to about 5 wt. %, about 0.07 wt. % to about 5 wt. %, about 0.1 wt. % to about 5 wt. %, about 0.2 wt. % to about 5 wt. %, about 0.3 wt. % to about 5 wt. %, about 0.4 wt. % to about 5 wt. %, about 0.5 wt. % to about 5 wt. %, about 0.6 wt. % to about 5 wt. %, about 0.7 wt. % to about 5 wt. %, about 0.8 wt. % to about 5 wt. %, about 0.9 wt. % to about 5 wt. %, about 1.0 wt. % to about 5 wt. %, about 0.05 wt. % to about 3.0 wt. %, about 0.07 wt. % to about 3.0 wt. %, about 0.1 wt. % to about 3.0 wt. %, about 0.05 wt. % to about 2.5 wt. %, about 0.05 wt. % to about 2.0 wt. %, about 0.05 wt. % to about 1.5 wt. %, about 0.05 wt. % to about 1.0 wt. %, about 0.07 wt. % to about 3.0 wt. %, about 0.07 wt. % to about 2.5 wt. %, about 0.07 wt. % to about 2.0 wt. %, about 0.07 wt. % to about 1.5 wt. %, about 0.07 wt. % to about 1.0 wt. %. In some embodiments, the abrasive particles are present in the composition at a concentration by weight, relative to the total weight of the composition, of about 0.03 wt. % to about 0.5 wt. %, about 0.05 to about 0.07 wt. %, about 0.07 wt. % to about 0.5 wt. %, about 0.1 wt. % to about 0.5 wt. %, about 0.03 wt. % to about 0.3 wt. %, about 0.05 wt. % to about 0.3 wt. %, about 0.05 wt. % to about 0.3 wt. %, about 0.07 wt. % to about 0.3 wt. %, about 0.1 wt. % to about 3 wt. %, about 0.1 wt. % to about 2.5 wt. %, about 0.1 wt. % to about 2 wt. %, about 0.1 wt. % to about 1.5 wt. %, about 0.1 wt. % to about 1 wt. %, or any range or value therein between. In some embodiments, the abrasive particles are present in the composition at a concentration by weight, relative to the total weight of the composition, of about 0.001 wt. % to about 10.0 wt. %, about 0.005 wt. % to about 5.0 wt. %, about 0.01 wt. % to about 3.0 wt. %, about 0.03 wt. % to about 2.0 wt. %, about 0.07 wt. % to about 1.0 wt. %, or any range or value therein between.

In some embodiments, the abrasive particles comprise silica (e.g., are colloidal silica particles). The number of silanol groups per unit surface area of silica particles (hereinafter, also referred to as a “density of a silanol group” or “silanol group density”) is not particularly limited. In some embodiments, the silica particles have a silanol group density of greater than or equal to 0/nm², greater than or equal to 1/nm², greater than or equal to 1.1/nm², greater than or equal to 1.2/nm², greater than or equal to 1.3/nm², greater than or equal to 1.4/nm², greater than or equal to 1.5/nm², greater than or equal to 1.6/nm², greater than or equal to 1.7/nm², greater than or equal to 1.8/nm², greater than or equal to 1.9/nm², greater than or equal to 2/nm², greater than or equal to 2.1/nm², greater than or equal to 2.2/nm², greater than or equal to 2.3/nm², greater than or equal to 2.4/nm², greater than or equal to 2.5/nm², greater than or equal to 3.0/nm², greater than or equal to 3.5/nm², greater than or equal to 4.0/nm², greater than or equal to 4.5/nm², greater than or equal to 5.0/nm², greater than or equal to 5.1/nm², greater than or equal to 5.2/nm², greater than or equal to 5.3/nm², greater than or equal to 5.4/nm², greater than or equal to 5.5/nm², greater than or equal to 5.6/nm², greater than or equal to 5.7/nm², greater than or equal to 5.8/nm², greater than or equal to 5.9/nm², greater than or equal to 6.0/nm², greater than or equal to 6.1/nm², greater than or equal to 6.2/nm², greater than or equal to 6.3/nm², greater than or equal to 6.4/nm², greater than or equal to 6.5/nm², greater than or equal to 6.6/nm², greater than or equal to 6.7/nm², greater than or equal to 6.8/nm², greater than or equal to 6.9/nm², greater than or equal to 7.0/nm², greater than or equal to 7.1/nm², greater than or equal to 7.2/nm², greater than or equal to 7.3/nm², greater than or equal to 7.4/nm², greater than or equal to 7.5/nm², greater than or equal to 7.6/nm², greater than or equal to 7.7/nm², greater than or equal to 7.8/nm², greater than or equal to 7.9/nm², greater than or equal to 8.0/nm², greater than or equal to 8.5/nm², greater than or equal to 9.0/nm², greater than or equal to 9.5/nm², greater than or equal to 10.0/nm², or any range or value therein between. The colloidal silica used in the present example had a silanol group density of about 5.7 to 6.0/nm².

In some embodiments, the silica particles have a silanol group density of 10.0/nm² or less, 9.5/nm² or less, 9.0/nm² or less, 8.5/nm² or less, 8.0/nm² or less, 7.5/nm² or less, 7.0/nm² or less, 6.5/nm² or less, 6.0/nm² or less, 5.5/nm² or less, 5.0/nm² or less, or any range or value therein between.

In some embodiments, the silica particles have a silanol group density of 1.0/nm² to 10.0/nm², 1.5/nm² to 9.5/nm², 2.0/nm² to 9.0/nm², 2.5/nm² to 8.5/nm², 3.0/nm² to 8.0/nm², 4.5/nm² to 7.5/nm², 5.0/nm² to 7.0/nm², 5.5/nm² to 6.5/nm², or any range or value therein.

The silanol group density per unit surface area of the abrasive particles (unit: number/nm² (/nm²)), namely the number of silanol groups per unit surface area of the abrasive grains, can be calculated by the Sears method, described in Analytical Chemistry, vol. 28. No. 12, 1956, 1982-1983 by G. W. Sears and using neutralization titration. The silanol group density per unit surface area of the abrasive particles can be calculated by measuring or calculating the parameters by the following measuring method or computation method followed by calculation by the method below.

More specifically, C in the following expression is the total mass of the abrasive particles, and S in the following expression is the BET specific surface area of the abrasive particles. Further specifically, 1.50 g of the abrasive particles are first collected into a 200-ml beaker as solid matter, and 100 ml of pure water is added to prepare slurry. Then, 30 g of sodium chloride is added thereto to be dissolved. Subsequently, 1 N hydrochloric acid is added to adjust the pH of the slurry to 3.0 to 3.5, followed by dilution of the slurry with pure water to 150 mL.

Then, 0.1 N sodium hydroxide is added to this slurry at 25° C. with an automatic titrator (available from HIRANUMA Co., Ltd., COM-1700) to adjust the pH to 4.0. Furthermore, pH titration is performed to measure the volume V [L] of 0.1 N sodium hydroxide solution required for increasing the pH from 4.0 to 9.0. The average silanol group density (silanol group density) can be calculated by the following expression:

ρ=(c×V×N_{A})/(C×S)
wherein ρ represents the average silanol group density (silanol group density) (silanol groups/nm²),
c represents the concentration (mol/L) of the sodium hydroxide solution used for the titration,
V represents the volume (L) of the sodium hydroxide solution required for increasing the pH from 4.0 to 9.0,
N_{A} represents Avogadro's constant (number/mol),
C represents the total mass of the abrasive particles (solid content) (g), and
S represents the weighted average value of the BET specific surface area of the abrasive particles (nm²/g). The BET specific surface area is the specific surface area of the abrasive particles measured by the BET method with a “MacsorbHM model-1210”, which is available from Mountech Co., Ltd.

In some embodiments, the abrasive particles have a zeta potential of less than or equal to 40 mV, less than or equal to 35 mV, less than or equal to 30 mV, less than or equal to 28 mV, less than or equal to 26 mV, less than or equal to 24 mV, less than or equal to 22 mV, less than or equal to 20 mV, less than or equal to 18 mV, less than or equal to 16 mV, less than or equal to 14 mV, less than or equal to 12 mV, less than or equal to 11 mV, less than or equal to 10 mV, less than or equal to 9 mV, less than or equal to 8 mV, or any range or value therein between in the composition. In some embodiments, the abrasive particles have a zeta potential of greater than or equal to 0 mV, greater than or equal to 2 mV, greater than or equal to 4 mV, or any range or value therein between in the composition. In some embodiments, the abrasive particles have a zeta potential of greater than or equal to 5 mV to less than or equal to 10 mV, or any range or value therein between in the composition. In some embodiments, the abrasive particles have a zeta potential of less than 10 mV in the composition.

In some embodiments, the silica particles have a zeta potential of less than or equal to 40 mV, less than or equal to 35 mV, less than or equal to 30 mV, less than or equal to 28 mV, less than or equal to 26 mV, less than or equal to 24 mV, less than or equal to 22 mV, less than or equal to 20 mV, less than or equal to 18 mV, less than or equal to 16 mV, less than or equal to 14 mV, less than or equal to 12 mV, less than or equal to 11 mV, less than or equal to 10 mV, less than or equal to 9 mV, less than or equal to 8 mV, or any range or value therein between in the composition. In some embodiments, the silica particles have a zeta potential of greater than or equal to 0 mV, greater than or equal to 2 mV, greater than or equal to 4 mV, or any range or value therein between in the composition. In some embodiments, the silica particles have a zeta potential of greater than or equal to 5 mV to less than or equal to 10 mV, or any range or value therein between in the composition.

In some embodiments, the abrasives comprise unmodified silica particles having an average primary particle diameter of 5 nm to 15 nm and a zeta potential of less than 6 mV in the composition, and are present in the composition at a concentration of greater than or equal to 0.001 wt. %, greater than or equal to 0.005 wt. %, greater than or equal to 0.01 wt. %, or greater than or equal to 0.05 wt. % relative to the total weight of the composition.

In some embodiments the abrasives comprise unmodified silica particles having an average primary particle diameter of 5 nm to 15 nm and a zeta potential of less than 6 mV in the composition, and are present in the composition at a concentration of 0.5 wt. % to 5 wt. %, relative to the total weight of the composition. The abrasive particles (e.g., colloidal silica) in the polishing composition are measured for zeta potential for example with a Zetasizer Nano ZS, which is available from Malvern Panalytical Ltd., herein.

### Inhibitors

Polishing compositions according to the present disclosure comprise one or more inhibitors. In some embodiments, polishing compositions according to the present disclosure comprise a first inhibitor and a second inhibitor. In some embodiments, polishing compositions according to the present disclosure comprise more than two inhibitors (e.g., three, four, or five inhibitors). The one or more inhibitors slow the static etch rate of polishing compositions according to the present disclosure, such that the molybdenum removal rate (from polishing) is high, while the molybdenum static etch rate is low, affording high ratio of MO_{RR} to SER. The first inhibitor can be a diamine. The second inhibitor can be a triamine. The diamine can have two —NH₂ groups in each molecule. The triamine can have three —NH₂ groups in each molecule.

In some embodiments, the one or more inhibitors comprises a monoamine, a diamine, a triamine, a tetraamine, or any combination thereof. In some embodiments, the weight proportion of the diamine and the triamine to the amines present in the polishing compositions is greater than or equal to 85 wt. %, greater than or equal to 90 wt. %, greater than or equal to 95 wt. %, or greater than or equal to 99 wt. % (upper limit: 100 wt. %).

In some embodiments, the one or more inhibitors contain a diamine and a triamine. In some embodiments, the ratio of the weight of the diamine to the weight of the triamine contained in the polishing compositions is greater than or equal to 1, greater than 1, greater than or equal to 1.5, greater than or equal to 2, greater than or equal to 2.5, greater than or equal to 3, greater than or equal to 3.5, or greater than or equal to 4. It is particularly preferred that the ratio be greater than 1. Reasons therefor is as follows. It is conceivable that the triamine has a high inhibitory effect on etching, but has an adverse effect of deteriorating the polishing removal rate markedly. It is conceivable that meanwhile, the diamine has a moderate inhibitory effect on etching, and has a mild adverse effect of deteriorating the polishing removal rate as compared with that of the triamine. The desired effect of the present invention can therefore be efficiently achieved using the diamine mainly (using the diamine in a larger amount than that of the triamine). In some embodiments, the ratio of the weight of the diamine to the weight of the triamine contained in the polishing composition is less than or equal to 50, less than or equal to 40, less than or equal to 30, less than or equal to 20, less than or equal to 10, less than or equal to 9, less than or equal to 8, less than or equal to 7, less than or equal to 6, less than or equal to 5, or less than or equal to 4. In some embodiments, the ratio of the weight of the diamine to the weight of the triamine contained in the polishing composition is greater than 1 and less than or equal to 40. In some embodiments, the amino groups of the diamine are bound to the terminal of the amine compound. In some embodiments, the amino groups of the triamine are bound to the terminal of the amine compound. In some embodiments, the one or more inhibitors comprises a polyether amine (e.g., the JEFFAMINE® polyetheramines sold by Huntsman International LLC).

In some embodiments, the diamine is represented by the formula H₂N-(AO)ₓ-A-NH₂ wherein A are each independently a divalent alkylene group having 1 to 4 carbon atoms, e.g., a methylene group, an ethylene group, a trimethylene group, a propylene group, or a butylene group, x can be greater than or equal to 1 and less than or equal to 50, greater than or equal to 2 and less than or equal to 30, greater than or equal to 3 and less than or equal to 25, or greater than or equal to 4 and less than or equal to 10, and e.g., x can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or any range or value therein between.

In some embodiments, in the formula H₂N-(AO)ₓ-A-NH₂, (AO)ₙ is a single structure of an ethyleneoxide group or a propyleneoxide group, x is greater than or equal to 1 and less than or equal to 50, greater than or equal to 2 and less than or equal to 30, greater than or equal to 3 and less than or equal to 25, or greater than or equal to 4 and less than or equal to 10, and e.g., x can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, or any range or value therein between.

In some embodiments, in the formula H₂N-(AO)ₓ-A-NH₂, (AO)ₙ is a block structure of propyleneoxide group-ethyleneoxide group-propyleneoxide group, the total number of moles of the propylene groups added is greater than or equal to 1 and less than or equal to 10, greater than or equal to 2 and less than or equal to 9, or greater than or equal to 3 and less than or equal to 8, e.g., the total number can be 1, 2, 3, 4, 5, 6, 7, 8, 9, 10, or any range or value therein between, the average number of moles of the ethylene groups added can be greater than or equal to 1 and less than or equal to 40, greater than or equal to 2 and less than or equal to 30, greater than or equal to 3 and less than or equal to 20, and e.g., the average number can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, or any range or value therein between. In the present embodiment, the total average number of moles of the propylene groups added may be smaller than the average number of moles of the ethylene groups added.

In some embodiments, the triamine is represented by the formula C{—R}{—R¹(OA)ₓ-NH₂}{—R²(OA)_{y}-NH₂}{—R³(OA)_{z}-NH₂}, A are each independently a divalent alkylene group having 1 to 4 carbon atoms, e.g., a methylene group, an ethylene group, a trimethylene group, a propylene group, or a butylene group, R is a hydrogen atom or an alkyl group having 1 to 4 carbon atoms, 1 to 3 carbon atoms, or 1 or 2 carbon atoms, R¹ to R³ are each independently an alkylene group having 1 to 4 carbon atoms, 1 to 3 carbon atoms, or 1 or 2 carbon atoms, x, y, and z are each independently greater than or equal to 1 and less than or equal to 30, greater than or equal to 2 and less than or equal to 20, greater than or equal to 3 and less than or equal to 10, or greater than or equal to 4 and less than or equal to 9, x, y, and z are each independently, e.g., 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, or any range or value therein between, and the sum of x, y, and z is 3 to 90, 4 to 60, 5 to 30, 5 to 27, or 6 to 24.

In some embodiments, the one or more inhibitors comprises a polyoxyethylene ether monoamine, a polyoxyethylene ether diamine, a polyoxyethylene ether triamine, a polyoxypropylene ether monoamine, a polyoxypropylene ether diamine, a polyoxypropylene ether triamine, a polyoxyethylene/polyoxypropylene ether monoamine, a polyoxyethylene/polyoxypropylene ether diamine, a polyoxyethylene/polyoxypropylene ether triamine, or any combination thereof. It should be understood that, “polyoxypropylene ether diamine” and “polyoxypropylene ether triamine”, described above as examples, are synonymous with “polyoxypropylene diamine” and “polyoxypropylene triamine”, respectively. The other examples are understood in the same way.

In some embodiments, the one or more inhibitors comprises a diamine having a structure corresponding to Formula I:

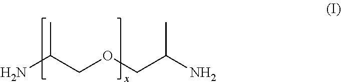

wherein x is an integer between 2 and 50. Non-limiting examples of such diamines include JEFFAMINE® D-230 (CAS No. 9046-10-0), JEFFAMINE® D-400 (CAS No. 9046-10-0), and JEFFAMINE® D-2000 (CAS No. 9046-10-0).

In some embodiments, the one or more inhibitors comprises a diamine corresponding to the structure of Formula II below:

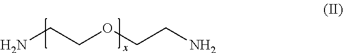

wherein x is an integer between 2 and 50. Non-limiting examples of such diamines include 3,6-dioxaoctamethylenediamine (CAS No. 929-59-9; JEFFAMINE® EDR-148, Huntsman).

In some embodiments, the one or more inhibitors comprises a triamine having a structure corresponding to the structure of Formula III below:

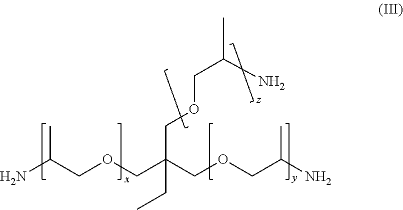

wherein x, y, and z are each independently integers between 1 and 20, and the average of (x+y+z) in the triamine inhibitor is between 3 and 30 (e.g., ˜5.3 or ˜11.3). Non-limiting examples of such triamines include JEFFAMINE® XTJ-669 and JEFFAMINE® T-403 (CAS No. 39423-51-3). Additional triamines may include compounds not encompassed by Formula III, including but not limited to Epomin SP-006 (CAS No. 106899-94-9; aziridine polymer with N-(2-aminoethyl)-1,2-ethanediamine). In some embodiments, the one or more inhibitors comprises a polyether triamine comprising ethylene oxide groups, propylene oxide groups, or a combination thereof. In some embodiments, the one or more inhibitors comprises an amine-terminated trimethylolpropane tris [poly (propylene glycol)] ether. Amine-terminated trimethylolpropane tris [poly(propylene glycol)] ether is synonymous with trimethylolpropane tris[poly(propylene glycol), amine terminated] ether.

In some embodiments, the one or more inhibitors comprises a monoamine corresponding to the structure of Formula IV below:

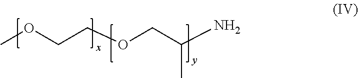

wherein x and y are each independently integers between 1 and 50. In some embodiments, the ratio of propylene oxide (y) to ethylene oxide (x) is between 1:50 and 50:0 (e.g., 9:1, 3:19, 29:6, 10:31). Non-limiting examples of such monoamines include JEFFAMINE® M-600 (CAS No. 77110-54-4), JEFFAMINE® M-1000, JEFFAMINE® M-2005, and JEFFAMINE® M-2070. Additional triamines may include compounds not encompassed by Formula IV, including but not limited to butoxypropylamine (CAS No. 16499-88-0).

In some embodiments, polishing compositions according to the present disclosure comprise 3,6-dioxaoctamethylenediamine as a first inhibitor and a compound according to Formula III wherein (x+y+z) is ˜5.3 (e.g., JEFFAMINE® T-403).

The one or more inhibitors may be present in the polishing composition at any suitable concentration for reducing the molybdenum static etch rate while achieving a high molybdenum removal rate, without reducing the polishing composition stability. In some embodiments, the one or more inhibitors are present in the polishing composition, individually or collectively, at a concentration (by weight relative to the total weight of the composition) of greater than or equal to about 0.001 wt. %, greater than or equal to about 0.005 wt. %, greater than or equal to about 0.01 wt. %, greater than or equal to about 0.02 wt. %, greater than or equal to about 0.03 wt. %, greater than or equal to about 0.04 wt. %, greater than or equal to about 0.05 wt. %, greater than or equal to about 0.06 wt. %, greater than or equal to about 0.07 wt. %, greater than or equal to about 0.08 wt. %, greater than or equal to about 0.09 wt. %, greater than or equal to about 0.1 wt. %, greater than or equal to about 0.2 wt. %, greater than or equal to about 0.3 wt. %, greater than or equal to about 0.4 wt. %, greater than or equal to about 0.5 wt. %, greater than or equal to about 0.6 wt. %, greater than or equal to about 0.7 wt. %, greater than or equal to about 0.8 wt. %, greater than or equal to about 0.9 wt. %, greater than or equal to about 1.0 wt. %, greater than or equal to about 1.5 wt. %, greater than or equal to about 2.0 wt. %, greater than or equal to about 2.5 wt. %, greater than or equal to about 3.0 wt. %, greater than or equal to about 3.5 wt. %, greater than or equal to about 4.0 wt. %, greater than or equal to about 4.5 wt. %, greater than or equal to about 5 wt. %, greater than or equal to about 6 wt. %, greater than or equal to about 7 wt. %, greater than or equal to about 8 wt. %, greater than or equal to about 9 wt. %, greater than or equal to about 10 wt. %, or any range or value therein between.

In some embodiments, the one or more inhibitors are present in the polishing composition, individually or collectively, at a concentration (by weight relative to the total weight of the composition) of less than or equal to about 10 wt. %, less than or equal to about 9 wt. %, less than or equal to about 8 wt. %, less than or equal to about 7 wt. %, less than or equal to about 6 wt. %, less than or equal to about 5 wt. %, less than or equal to about 4.5 wt. %, less than or equal to about 4.0 wt. %, less than or equal to about 3.5 wt. %, less than or equal to about 3.0 wt. %, less than or equal to about 2.5 wt. %, less than or equal to about 2.0 wt. %, less than or equal to about 1.5 wt. %, less than or equal to about 1.0 wt. %, less than or equal to about 0.9 wt. %, less than or equal to about 0.8 wt. %, less than or equal to about 0.7 wt. %, less than or equal to about 0.6 wt. %, less than or equal to about 0.5 wt. %, less than or equal to about 0.4 wt. %, less than or equal to about 0.3 wt. %, less than or equal to about 0.2 wt. %, less than or equal to about 0.1 wt. %, less than or equal to about 0.05 wt. %, less than or equal to about 0.01 wt. %, less than or equal to about 0.005 wt. %, or any range or value therein between.

In some embodiments, the one or more inhibitors are present in the polishing composition, individually or collectively, at a concentration (by weight relative to the total weight of the composition) of about 0.005 wt. % to about 10 wt. %, about 0.005 wt. % to about 5 wt. %, about 0.005 wt. % to about 1 wt. %, about 0.005 wt. % to about 0.7 wt. %, about 0.005 wt. % to about 0.5 wt. %, about 0.005 wt. % to about 0.3 wt. %, about 0.005 wt. % to about 0.2 wt. %, about 0.005 wt. % to about 0.15 wt. %, about 0.01 wt. % to about 10 wt. %, about 0.01 wt. % to about 5 wt. %, about 0.01 wt. % to about 1 wt. %, about 0.01 wt. % to about 0.7 wt. %, about 0.01 wt. % to about 0.5 wt. %, about 0.01 to about 0.2 wt. %, about 0.01 to about 0.15 wt. %, about 0.05 wt. % to about 10 wt. %, about 0.05 wt. % to about 5 wt. %, about 0.05 wt. % to about 1 wt. %, about 0.05 wt. % to about 0.7 wt. %, about 0.05 wt. % to about 0.5 wt. %, about 0.05 wt. % to about 0.3 wt. %, about 0.05 wt. % to about 0.2 wt. %, about 0.05 wt. % to about 0.15 wt. %, about 0.01 wt. % to about 0.1 wt. %, about 0.05 wt. % to about 5 wt. %, or any range or value therein. In some embodiments, one or more inhibitors are present in the polishing composition, individually or collectively, at a concentration (by weight relative to the total weight of the composition) of about 0.05 wt. % to about 0.1 wt. %, or any range or value therein between.

In some embodiments, polishing compositions according to the present disclosure comprise 3,6-dioxaoctamethylenediamine (e.g., JEFFAMINE® EDR-148) as a first inhibitor, present at a concentration of about 0.05 wt. % to about 5 wt. %, relative to the total weight of the composition, and a compound according to Formula III wherein (x+y+z) is ˜5.3 (e.g., JEFFAMINE® T-403), present at a concentration of about 0.01 wt. % to about 0.1 wt. %, relative to the total weight of the composition.

In some embodiments, polishing compositions according to the present disclosure comprise a first inhibitor and a second inhibitor. In some embodiments, the concentration (wt. %) ratio of the first inhibitor to the second inhibitor is less than or equal to about 50, less than or equal to 40, less than or equal to 30, less than or equal to 20, less than or equal to 10, less than or equal to 9, less than or equal to 8, less than or equal to 7, less than or equal to 6, less than or equal to 5, or less than or equal to 4. In some embodiments, the concentration (wt. %) ratio of the first inhibitor to the second inhibitor is greater than or equal to 1, greater than 1, greater than or equal to 1.5, greater than or equal to 2, greater than or equal to 2.5, greater than or equal to 3, greater than or equal to 3.5, or greater than or equal to 4. The term “about” described with the first value herein can also modify the subsequently exemplified values. In some embodiments, the concentration (wt. %) ratio of the first inhibitor to the second inhibitor is about 1:50, 1:40, 1:30, 1:20, 1:10, 1:9, 1:8, 1:7, 1:6, 1:5, 1:4, 1:3, 1:2, 1:1, 2:1, 3:1, 4:1, 5:1, 6:1, 7:1, 8:1, 9:1, 10:1, 20:1, 30:1, 40:1, or 50:1.

The one or more inhibitors may have any suitable molecular weight for ensuring good dispersion of the one or more inhibitors in the polishing composition and sufficiently suppressing the static etch rate of the polishing composition on Mo. The following descriptions of molecular weights of the inhibitors contained in the polishing composition according to the present disclosure are applied to both description of molecular weight of the first inhibitor and description of molecular weight of the second inhibitor unless otherwise specified. In some embodiments, the inhibitor has a molecular weight of at least about 100 g/mol, at least about 150 g/mol, at least about 200 g/mol, at least about 250 g/mol, at least about 300 g/mol, at least about 350 g/mol, at least about 400 g/mol, at least about 450 g/mol, at least about 500 g/mol, at least about 550 g/mol, at least about 600 g/mol, at least about 700 g/mol, at least about 800 g/mol, at least about 900 g/mol, at least about 1000 g/mol, at least about 1100 g/mol, at least about 1200 g/mol, at least about 1300 g/mol, at least about 1400 g/mol, at least about 1500 g/mol, at least about 1600 g/mol, at least about 1700 g/mol, at least about 1800 g/mol, at least about 1900 g/mol, at least about 2000 g/mol, at least about 2100 g/mol, at least about 2200 g/mol, at least about 2300 g/mol, at least about 2400 g/mol, at least about 2500 g/mol, at least about 2600 g/mol, at least about 2700 g/mol, at least about 2800 g/mol, at least about 2900 g/mol, at least about 3000 g/mol, at least about 3500 g/mol, at least about 4000 g/mol, at least about 4500 g/mol, at least about 5000 g/mol, or any range or value therein between. The molecular weights as used herein can be weight average molecular weights. The weight average molecular weights can be measured by gel permeation chromatography (GPC) using polystyrene as the standard substance. In some embodiments, the molecular weight of the first inhibitor is lower than the molecular weight of the second inhibitor.

In some embodiments, the one or more inhibitors has a molecular weight of no greater than about 5000 g/mol, no greater than about 4500 g/mol, no greater than about 4000 g/mol, no greater than about 3500 g/mol, no greater than about 3000 g/mol, no greater than about 2500 g/mol, no greater than about 2400 g/mol, no greater than about 2300 g/mol, no greater than about 2200 g/mol, no greater than about 2100 g/mol, no greater than about 2000 g/mol, no greater than about 1900 g/mol, no greater than about 1800 g/mol, no greater than about 1700 g/mol, no greater than about 1600 g/mol, no greater than about 1500 g/mol, no greater than about 1400 g/mol, no greater than about 1300 g/mol, no greater than about 1200 g/mol, no greater than about 1100 g/mol, no greater than about 1000 g/mol, no greater than about 900 g/mol, no greater than about 800 g/mol, no greater than about 700 g/mol, no greater than about 600 g/mol, no greater than about 550 g/mol, no greater than about 500 g/mol, no greater than about 450 g/mol, no greater than about 400 g/mol, no greater than about 350 g/mol, no greater than about 300 g/mol, no greater than about 250 g/mol, no greater than about 200 g/mol, no greater than about 150 g/mol, no greater than about 100 g/mol, or any range or value therein between.

In some embodiments, the one or more inhibitors has a molecular weight of 100 g/mol to 2000 g/mol, 100 g/mol to 1500 g/mol, 100 g/mol to 1000 g/mol, 100 g/mol to 500 g/mol, 300 g/mol to 2000 g/mol, 300 g/mol to 1500 g/mol, 300 g/mol to 1000 g/mol, 300 g/mol to 500 g/mol, 500 g/mol to 2000 g/mol, 500 g/mol to 1500 g/mol, 500 g/mol to 1000 g/mol, or any range or value therein between.

In some embodiments, the second inhibitor has a molecular weight of 300 to 1000, or 300 to 500. In some embodiments, the first inhibitor has a molecular weight of 100 to 300.

### Oxidizers

Polishing compositions according to the present disclosure comprise one or more oxidizers. The oxidizer can oxidatively react with the surface of the object to be polished (especially Mo) in the polishing process to reduce the hardness of the surface, resulting in making the surface fragile. As long as the oxidizer is a substance having sufficient oxidation-reduction potential to exhibit the action of oxidizing the surface of the object to be polished, the oxidizer may be any oxidizer. For example, the oxidizer can be a substance having higher oxidation-reduction potential at a pH at which polishing is performed than the oxidation-reduction potential of the material constituting the object to be polished. The above-mentioned pH at which the polishing is performed is generally the same as the pH of the polishing composition. Powder of the material is dispersed in water to prepare slurry. The pH of the slurry is adjusted to the same pH as that of the polishing composition. The slurry is measured for oxidation-reduction potential (oxidation-reduction potential with respect to the reference hydrogen electrode at a liquid temperature of 25° C.) with a commercial oxidation-reduction potentiometer. The thus measured value is adopted as the oxidation-reduction potential of the material constituting the object to be polished. The polishing composition may comprise more than two oxidizers (e.g., three, four, five, or more oxidizers). In some embodiments, the oxidizer comprises halogen oxoacids or salts thereof. Examples of the salts include sodium or potassium. In some embodiments, the oxidizer comprises periodic acid (e.g., orthoperiodic acid (H₅IO₆), metaperiodic acid (HIO₄), or a combination thereof), iodic acid (HIO₃), sodium iodate (NaIO₃), potassium iodate (KIO₃), or a combination thereof. In some embodiments, the oxidizer comprises potassium iodate (KIO₃). In several embodiments, the ratio of the halogen oxoacids or the salts thereof to the oxidizer contained in the polishing composition is greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % (upper limit: 100 wt. %). In several embodiments, the ratio of at least one of potassium iodate and periodic acid to the oxidizer contained in the polishing composition is greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % (upper limit: 100 wt. %).

In some embodiments, the oxidizer comprises one or more transition metal compounds (e.g., transition metal halides). In some embodiments, the first oxidizer is not a peroxide. In some embodiments, the first oxidizer comprises one or more compounds selected from: a silver (II) salt, an iron (III) salt, permanganic acid, chromic acid, dichromatic acid, hypochlorous acid, hypobromous acid, hypoiodous acid, chloric acid, chlorous acid, perchloric acid, bromic acid, iodic acid, periodic acid, dichloroisocyanuric acid, potassium iodate, potassium permanganate, and salts thereof.

In some embodiments, the second oxidizer comprises one or more peroxides. In some embodiments, the second oxidizer comprises one or more compounds selected from: hydrogen peroxide, sodium peroxide, barium peroxide, ozone water, peroxodisulfuric acid, peroxophosphoric acid, peroxosulfuric acid, peroxoboric acid, performic acid, peracetic acid, perbenzoic acid, perphthalic acid, persulfuric acid, and salts thereof.

In some embodiments, the polishing composition comprises no hydrogen peroxide, or comprises hydrogen peroxide at a concentration of less than 0.001 mass % or less than 0.0001 mass %, if any.

The oxidizer be present in the polishing composition at any suitable concentration for reducing the molybdenum static etch rate while achieving a high molybdenum removal rate, without reducing the polishing composition stability.

In some embodiments, the one or more oxidizers are present in the polishing composition, individually or collectively, at a concentration (by weight relative to the total weight of the composition) of greater than or equal to about 0.001 wt. %, greater than or equal to about 0.005 wt. %, greater than or equal to about 0.01 wt. %, greater than or equal to about 0.02 wt. %, greater than or equal to about 0.03 wt. %, greater than or equal to about 0.04 wt. %, greater than or equal to about 0.05 wt. %, greater than or equal to about 0.06 wt. %, greater than or equal to about 0.07 wt. %, greater than or equal to about 0.08 wt. %, greater than or equal to about 0.09 wt. %, greater than or equal to about 0.1 wt. %, greater than or equal to about 0.2 wt. %, greater than or equal to about 0.3 wt. %, greater than or equal to about 0.4 wt. %, greater than or equal to about 0.5 wt. %, greater than or equal to about 0.6 wt. %, greater than or equal to about 0.7 wt. %, greater than or equal to about 0.8 wt. %, greater than or equal to about 0.9 wt. %, greater than or equal to about 1.0 wt. %, greater than or equal to about 1.5 wt. %, greater than or equal to about 2.0 wt. %, greater than or equal to about 2.5 wt. %, greater than or equal to about 3.0 wt. %, greater than or equal to about 3.5 wt. %, greater than or equal to about 4.0 wt. %, greater than or equal to about 4.5 wt. %, greater than or equal to about 5 wt. %, greater than or equal to about 6 wt. %, greater than or equal to about 7 wt. %, greater than or equal to about 8 wt. %, greater than or equal to about 9 wt. %, greater than or equal to about 10 wt. %, or any range or value therein between.

In some embodiments, the one or more oxidizers are present in the polishing composition, individually or collectively, at a concentration (by weight relative to the total weight of the composition) of less than or equal to about 10 wt. %, less than or equal to about 9 wt. %, less than or equal to about 8 wt. %, less than or equal to about 7 wt. %, less than or equal to about 6 wt. %, less than or equal to about 5 wt. %, less than or equal to about 4.5 wt. %, less than or equal to about 4.0 wt. %, less than or equal to about 3.5 wt. %, less than or equal to about 3.0 wt. %, less than or equal to about 2.5 wt. %, less than or equal to about 2.0 wt. %, less than or equal to about 1.5 wt. %, less than or equal to about 1.0 wt. %, less than or equal to about 0.9 wt. %, less than or equal to about 0.8 wt. %, less than or equal to about 0.7 wt. %, less than or equal to about 0.6 wt. %, less than or equal to about 0.5 wt. %, less than or equal to about 0.4 wt. %, less than or equal to about 0.3 wt. %, less than or equal to about 0.2 wt. %, less than or equal to about 0.1 wt. %, less than or equal to about 0.05 wt. %, less than or equal to about 0.01 wt. %, less than or equal to about 0.005 wt. %, or any range or value therein between.

In some embodiments, the one or more oxidizers are present in the polishing composition, individually or collectively, at a concentration (by weight relative to the total weight of the composition) of about 0.001 wt. % to about 10 wt. %, about 0.001 wt. % to about 5 wt. %, about 0.001 wt. % to about 1 wt. %, about 0.001 wt. % to about 0.7 wt. %, about 0.001 wt. % to about 0.5 wt. %, about 0.001 wt. % to about 0.1 wt. %, about 0.001 wt. % to about 0.05 wt. %, about 0.001 wt. % to about 0.01 wt. %, about 0.005 wt. % to about 10 wt. %, about 0.005 wt. % to about 5 wt. %, about 0.005 wt. % to about 1 wt. %, about 0.005 wt. % to about 0.7 wt. %, about 0.005 wt. % to about 0.5 wt. %, about 0.005 wt. % to about 0.1 wt. %, about 0.005 wt. % to about 0.05 wt. %, about 0.005 wt. % to about 0.01 wt. %, about 0.01 wt. % to about 10 wt. %, about 0.01 wt. % to about 5 wt. %, about 0.01 wt. % to about 1 wt. %, about 0.01 wt. % to about 0.7 wt. %, about 0.01 wt. % to about 0.5 wt. %, about 0.01 wt. % to about 0.1 wt. %, about 0.05 wt. % to about 10 wt. %, about 0.05 wt. % to about 5.0 wt. %, about 0.05 wt. % to about 1.0 wt. %, about 0.05 wt. % to about 0.7 wt. %, about 0.05 wt. % to about 0.5 wt. %, about 0.05 wt. % to about 0.1 wt. %, about 0.05 wt. % to about 0.07 wt. %, about 0.1 wt. % to about 10 wt. %, about 0.1 wt. % to about 5.0 wt. %, about 0.1 wt. % to about 2.5 wt. %, about 0.1 wt. % to about 2.0 wt. %, about 0.1 wt. % to about 1.5 wt. %, about 0.1 wt. % to about 1.0 wt. %, about 0.1 wt. % to about 0.7 wt. %, about 0.1 wt. % to about 0.5 wt. %, about 0.5 wt. % to about 10 wt. %, about 0.5 wt. % to about 5.0 wt. %, about 0.5 wt. % to about 2.5 wt. %, about 0.5 wt. % to about 2.0 wt. %, about 0.5 wt. % to about 1.5 wt. %, about 0.5 wt. % to about 1.0 wt. %, about 0.5 wt. % to about 0.7 wt. %, about 1.0 wt. % to about 10.0 wt. %, about 1.0 wt. % to about 5.0 wt. %, about 1.0 wt. % to about 2.5 wt. %, about 1.0 wt. % to about 2.0 wt. %, about 1.0 wt. % to about 1.5 wt. %, or any range or value therein.

In some embodiments, the polishing composition comprises potassium iodate (KIO₃) at a concentration of about 0.1 wt. % to about 2.0 wt. %, relative to the total weight of the composition. In some embodiments, the polishing composition comprises periodic acid at a concentration of about 0.1 wt. % to about 2.0 wt. %, relative to the total weight of the composition.

### pH Adjusting Agent

In some embodiments, a composition according to the present disclosure may further comprise one or more pH adjusting agents to adjust the pH to a selected pH value. In some embodiments, the abrasive, the oxidizer comprising the halogen oxoacids or salts thereof, the first inhibitor comprising the diamine, and the second inhibitor comprising the triamine are not considered to be a pH adjusting agent. In some embodiments, the “additional ingredients (an antiseptic agent, an antifungal agent, and a biocide)” described below are not considered to be pH adjusting agents.

The pH adjusting agent is not particularly limited, and any suitable pH adjusting agent may be used to bring the pH of the composition into any desired range, as discussed above. In some embodiments, the one or more pH adjusting agents may comprise, consist essentially of, or consist of an inorganic compound, an organic compound, or combinations thereof. In some embodiments, the one or more pH adjusting agents may comprise inorganic acids (e.g., hydrochloric acid, hydrobromic acid, hydroiodic acid, sulfuric acid, nitric acid, boric acid, carbonic acid, hypophosphorous acid, phosphorous acid, and phosphoric acid); organic acids (e.g., carboxylic acids such as citric acid, formic acid, acetic acid, propionic acid, benzoic acid, salicylic acid, glyceric acid, oxalic acid, malonic acid, succinic acid, maleic acid, phthalic acid, malic acid, tartaric acid, and lactic acid); and/or organic sulfuric acids (e.g., methane sulfonic acid, ethane sulfonic acid, isethionic acid, etc.). In some embodiments, the one or more pH adjusting agents may comprise a divalent or higher acid of the above acid(s) (e.g., sulfuric acid, carbonic acid, phosphoric acid, oxalic acid, etc.), which may be in the form of a base when one or more protons (H⁺) can be released (e.g., ammonium hydrogen carbonate or ammonium hydrogen phosphate), but any counter-ion may be used (e.g., weakly basic cations, such as ammonium, triethanolamine, etc.). In some embodiments, the acid can release one or more protons (H⁺).

In some embodiments, the one or more pH adjusting agents may comprise one or more hydroxides of alkali metals (e.g., NaOH, KOH), or salts thereof (e.g., carbonates, hydrogen carbonates, sulfates, acetates, etc.); quaternary ammonium compounds (e.g., tetramethylammonium, tetraethylammonium, tetrabutylammonium, etc.); quaternary ammonium hydroxides (e.g., tetramethylammonium hydroxide, tetraethylammonium hydroxide, tetrabutylammonium hydroxide) or a salts thereof; ammonia; amines; or any other suitable pH adjusting agent.

In some embodiments, the pH adjuster comprises nitric acid (HNO₃). In some embodiments, the pH adjuster comprises KOH. In some embodiments, the pH adjuster comprises HNO₃, KOH, or a combination thereof.

In some embodiments, the amount of the pH adjuster (e.g., an inorganic acid) can be present in any amount for suitable for adjusting the pH of the polishing composition to the following desired range.

### pH of Polishing Composition

The pH adjusting agent can be present in any amount suitable for achieving a desired Mo RR removal rate and a desired low Mo SER. The pH of the polishing composition may be measured using any suitable method known in the art (e.g., using a ThermoFisher Scientific ORION™ VERSA STAR PRO™ pH/ISE/conductivity/dissolved oxygen multiparameter benchtop meter).

In some embodiments, the pH of the composition is less than or equal to about 8.0, less than or equal to about 7.8, less than or equal to about 7.6, less than or equal to about 7.4, less than or equal to about 7.2, less than or equal to about 7.0, less than or equal to about 6.8, less than or equal to about 6.6, less than or equal to about 6.4, less than or equal to about 6.2, less than or equal to about 6.0, less than or equal to about 5.9, less than or equal to about 5.8, less than or equal to about 5.7, less than or equal to about 5.6, less than or equal to about 5.5, less than or equal to about 5.4, less than or equal to about 5.3, less than or equal to about 5.2, less than or equal to about 5.1, less than or equal to about 5.0, less than or equal to about 4.9, less than or equal to about 4.8, less than or equal to about 4.7, less than or equal to about 4.6, less than or equal to about 4.5, less than or equal to about 4.4, less than or equal to about 4.3, less than or equal to about 4.2, less than or equal to about 4.1, less than or equal to about 4.0, less than or equal to about 3.9, less than or equal to about 3.8, less than or equal to about 3.7, less than or equal to about 3.6, less than or equal to about 3.5, less than or equal to about 3.4, less than or equal to about 3.3, less than or equal to about 3.2, less than or equal to about 3.1, less than or equal to about 3.0, less than or equal to about 2.9, less than or equal to about 2.8, less than or equal to about 2.7, less than or equal to about 2.6, less than or equal to about 2.5, less than or equal to about 2.4, less than or equal to about 2.3, less than or equal to about 2.2, less than or equal to about 2.1, less than or equal to about 2.0, or any range or value therein between.

In some embodiments, the pH of the composition is greater than or equal to about 1.0, greater than or equal to about 1.1, greater than or equal to about 1.2, greater than or equal to about 1.3, greater than or equal to about 1.4, greater than or equal to about 1.5, greater than or equal to about 1.6, greater than or equal to about 1.7, greater than or equal to about 1.8, greater than or equal to about 1.9, greater than or equal to about 2.0, greater than or equal to about 2.1, greater than or equal to about 2.2, greater than or equal to about 2.3, greater than or equal to about 2.4, greater than or equal to about 2.5, greater than or equal to about 2.6, greater than or equal to about 2.7, greater than or equal to about 2.8, greater than or equal to about 2.9, greater than or equal to about 3.0, greater than or equal to about 3.1, greater than or equal to about 3.2, greater than or equal to about 3.3, greater than or equal to about 3.4, greater than or equal to about 3.5, greater than or equal to about 3.6, greater than or equal to about 3.7, greater than or equal to about 3.8, greater than or equal to about 3.9, greater than or equal to about 4.0, greater than or equal to about 4.1, greater than or equal to about 4.2, greater than or equal to about 4.3, greater than or equal to about 4.4, greater than or equal to about 4.5, greater than or equal to about 4.6, greater than or equal to about 4.7, greater than or equal to about 4.8, greater than or equal to about 4.9, greater than or equal to about 5.0, greater than or equal to about 5.1, greater than or equal to about 5.2, greater than or equal to about 5.3, greater than or equal to about 5.4, greater than or equal to about 5.5, greater than or equal to about 5.6, greater than or equal to about 5.7, greater than or equal to about 5.8, greater than or equal to about 5.9, greater than or equal to about 6.0, greater than or equal to about 6.1, greater than or equal to about 6.2, greater than or equal to about 6.3, greater than or equal to about 6.4, greater than or equal to about 6.5, or any range or value therein between.

In some embodiments, the pH of the composition is about 1 to about 8.5, about 1 to about 7.5, about 1 to about 6.5, about 1 to about 5.5, about 1 to about 4.5, about 1 to about 3.5, about 1 to 2.5, about 1.5 to about 8.5, about 1.5 to about 7.5, about 1.5 to about 6.5, about 1.5 to about 5.5, about 1.5 to about 4.5, about 1.5 to about 3.5, about 1.5 to 2.5, about 2.0 to about 8.5, about 2.0 to about 7.5, about 2.0 to about 6.5, about 2.0 to about 5.5, about 2.0 to about 4.5, about 2.0 to about 3.5, about 2.0 to 2.5, about 1.5 to about 6, about 2 to about 6, about 2.5 to about 6, about 3 to about 6, about 1 to about 5.5, about 1.5 to about 5.5, about 2 to about 5.5, about 2.5 to about 5.5, about 3 to about 5.5, about 1 to about 5, about 1.5 to about 5, about 2 to about 5, about 2.5 to about 5, about 3 to about 5, about 1 to about 4.5, about 1.5 to about 4.5, about 2 to about 4.5, about 2.5 to about 4.5, about 3 to about 4.5, or any range or value therein between.

### Liquid Carrier

Polishing compositions according to the present disclosure may comprise a liquid carrier. The liquid carrier of the polishing composition is not particularly limited. In some embodiments, the liquid carrier is water, such as deionized water. The liquid carrier may also be an aqueous solution that has, e.g., an appropriate pH modifier contained therein. In some embodiments, the liquid carrier can comprise one or more organic solvents, such as an alcohol compound, e.g., glycol ethers of aliphatic alcohols and 3 to 10 carbon atoms having 2 to 6 carbon atoms. Examples of aliphatic alcohols with 2 to 6 carbon atoms include ethanol, 1-propanol, 2-propanol, 1-butanol, 2-butanol, tert-butanol, pentanol, hexanol, ethylene glycol, propylene glycol, 1,3-butanediol, 1,4-butanediol, 1,5-pentanediol, 1,6-hexanediol, glycerin, 1,2,4-butanetriol, 1,2,6-hexanetriol, erythritol, D-threitol, L-threilol, D-arabinitol, L-arabinitol, ribitol, xylitol, mannitol, and sorbitol. Examples of glycol ethers with 3 to 10 carbon atoms include methyl glycol, methyl diglycol, methyl triglycol, isopropyl glycol, isopropyl diglycol, butyl glycol, butyl diglycol, butyl triglycol, isobutyl glycol, isobutyl diglycol, hexyl glycol, hexyl diglycol, 2-ethylhexyl glycol, 2-ethylhexyl diglycol, aryl glycol, phenyl glycol, phenyl diglycol, benzyl glycol, methylpropylene glycol, methylpropylene diglycol, methylpropylene triglycol, propylpropylene glycol, propylpropylene diglycol, butylpropylene glycol, butylpropylene diglycol, and phenylpropylene glycol. In several embodiments, the liquid carrier contained in the polishing composition comprises water at greater than or equal to 80 wt. %, greater than or equal to 85 wt. %, greater than or equal to 90 wt. %, greater than or equal to 95 wt. %, greater than or equal to 98 wt. %, or greater than or equal to 99 wt. % (the upper limit is 100 wt. %).

### Additional Ingredients

In some embodiments, the composition may comprise other additives at any concentration. However, it is desirable not to add unnecessary components, which may cause the presence of surface defects. Thus, it is preferred that any other additives are present in relatively small concentrations (e.g., 0.1 wt. % or less, 0.05 wt. % or less, 0.01 wt. % or less, 0.005 wt. % or less, 0.001 wt. % or less, 0.0005 wt. % or less, 0.0001 wt. % or less, 0.0001 wt. % to 0.1 wt. %, 0.0001 wt. % to 0.01 wt. %, or 0.0001 wt. % to 0.001 wt. %, etc.) if they are present at all. Examples of other additives include antiseptic agents, antifungal agents, biocides (e.g., isothiazolinones such as methylisothiazolinone (“MIT”), benzisothiazolinone (“BIT”), 2-methyl-4-isothiazolin-3-one, etc.), dispersants (additives that improve the redispersibility of abrasive grains that have once settled), electrical conductivity adjusting agents (additives that adjust the electric conductivity of the polishing composition), abrasive grains other than the abrasive grains mentioned above, chelating agents, oxidizing agents, reducing agents, and dissolved gases.

In some embodiments, the composition comprises no basic amino acid, or comprises a basic amino acid at a concentration of less than 0.001 wt. %, less than 0.0005 wt. %, or less than 0.0001 wt. %, if any. In some embodiments, the composition comprises no amino acid, or comprises an amino acid at a concentration of less than 0.001 wt. %, less than 0.0005 wt. %, or less than 0.0001 wt. %, if any.

In some embodiments, one or more biocides is present in the composition at a concentration, relative to the total weight of the composition, of about 0.001 wt. % to about 1 wt. %, about 0.002 wt. % to about 1 wt. %, about 0.003 wt. % to about 1 wt. %, about 0.004 wt. % to about 1 wt. %, about 0.005 wt. % to about 1 wt. %, about 0.007 wt. % to about 1 wt. %, about 0.001 wt. % to about 0.5 wt. %, about 0.002 wt. % to about 0.5 wt. %, about 0.003 wt. % to about 0.5 wt. %, about 0.004 wt. % to about 0.5 wt. %, about 0.005 wt. % to about 0.5 wt. %, about 0.007 wt. % to about 0.5 wt. %, about 0.001 wt. % to about 0.3 wt. %, about 0.002 wt. % to about 0.3 wt. %, about 0.003 wt. % to about 0.3 wt. %, about 0.004 wt. % to about 0.3 wt. %, about 0.005 wt. % to about 0.3 wt. %, about 0.007 wt. % to about 0.3 wt. %, about 0.001 wt. % to about 0.1 wt. %, about 0.002 wt. % to about 0.1 wt. %, about 0.003 wt. % to about 0.1 wt. %, about 0.004 wt. % to about 0.1 wt. %, about 0.005 wt. % to about 0.1 wt. %, about 0.007 wt. % to about 0.1 wt. %, or any range or value therein between.

In some embodiments, provided are methods for producing polishing compositions. In some embodiments, the methods for producing polishing compositions comprise mixing an abrasive, an oxidizer comprising halogen oxoacids or salts thereof, a first inhibitor comprising a diamine, a second inhibitor comprising a triamine, and optionally contained ingredients. Although the ingredients may be mixed at any temperature, which is preferably 10 to 40° C. The ingredients may be heated for increasing the rate of dissolution. As long as the ingredients can be uniformly mixed, the mixing time may be any time. In some embodiments, the first inhibitor is added, followed by addition of the second inhibitor. In some embodiments, the polishing composition is prepared while the pH is prevented from varying to greater than 5 (or 4) during the addition of the first inhibitor. In some embodiments, the polishing composition is prepared while the pH is prevented from varying to greater than 5 (or 4) during the addition of the second inhibitor. The polishing composition is preferably prepared while the pH is prevented from varying to greater than 5 (or 4).

### Polishing Methods

In another aspect, which may be combined with any other aspect or embodiment, the present disclosure relates to a method for polishing an object comprising a Mo surface, the method comprising: contacting the Mo surface with the polishing composition of any of the embodiments disclosed herein using a polishing pad; and moving the polishing pad relative to the Mo surface while the polishing composition is in contact with the Mo surface to abrade the Mo surface. In the present disclosure, the object to be polished comprises Mo.

In some embodiments the molybdenum is removed from the molybdenum surface at a removal rate (RR) of greater than or equal to about 500 Å/min, greater than or equal to about 550 Å/min, greater than or equal to about 600 Å/min, greater than or equal to about 650 Å/min, greater than or equal to about 700 Å/min, greater than or equal to about 750 Å/min, greater than or equal to about 800 Å/min, greater than or equal to about 850 Å/min, greater than or equal to about 900 Å/min, greater than or equal to about 950 Å/min, greater than or equal to about 1000 Å/min, greater than or equal to about 1050 Å/min, greater than or equal to about 1100 Å/min, greater than or equal to about 1150 Å/min, greater than or equal to about 1200 Å/min, greater than or equal to about 1250 Å/min, greater than or equal to about 1300 Å/min, greater than or equal to about 1350 Å/min, greater than or equal to about 1400 Å/min, greater than or equal to about 1450 Å/min, greater than or equal to about 1500 Å/min, or any range or value therein between.

In some embodiments, the polishing achieves a low Mo SER. In some embodiments, the SER is less than or equal to about 800 Å/min, less than or equal to about 750 Å/min, less than or equal to about 700 Å/min, less than or equal to about 650 Å/min, less than or equal to about 600 Å/min, less than or equal to about 550 Å/min, less than or equal to about 500 Å/min, less than or equal to about 450 Å/min, less than or equal to about 400 Å/min, less than or equal to about 350 Å/min, less than or equal to about 300 Å/min, less than or equal to about 250 Å/min, less than or equal to about 200 Å/min, less than or equal to about 190 Å/min, less than or equal to about 180 Å/min, less than or equal to about 170 Å/min, less than or equal to about 160 Å/min, less than or equal to about 150 Å/min, less than or equal to about 140 Å/min, less than or equal to about 130 Å/min, less than or equal to about 120 Å/min, less than or equal to about 110 Å/min, less than or equal to about 100 Å/min, less than or equal to about 90 Å/min, less than or equal to about 80 Å/min, less than or equal to about 70 Å/min, less than or equal to about 60 Å/min, less than or equal to about 50 Å/min, less than or equal to about 40 Å/min, less than or equal to about 30 Å/min, less than or equal to about 20 Å/min, less than or equal to about 10 Å/min, or any range or value therein between.

In some embodiments, the polishing achieves a ratio of Mo RR to Mo SER of at least about 1.5, at least about 2, at least about 2.5, at least about 3, at least about 3.5, at least about 4, at least about 4.5, at least about 5, at least about 5.5, at least about 6, at least about 6.5, at least about 7, at least about 7.5, at least about 8, at least about 8.5, at least about 9, at least about 9.5, at least about 10, at least about 10.5, at least about 11, at least about 11.5, at least about 12, at least about 15, at least about 20, at least about 30, at least about 40, at least about 50, or greater.

### EXAMPLES

### Example 1

### Preparation of Polishing Compositions

To test the polishing performance of polishing compositions according the present disclosure in terms of Mo removal rate, Mo static etch rate suppression, and Mo RR-to-SER ratio, polishing compositions were prepared as follows:

For the exemplary polishing compositions used in the experiments below, polishing compositions were prepared by adding the following ingredients to a container, while mixing, in the amounts shown in Table 1 and in the following order: (1) deionized water; (2) oxidizer; (3) first inhibitor; (4) second inhibitor (optional); (5) abrasive particles; (6) pH adjuster. Since EPOMIN™ SP-006 had greater than or equal to four amines, the compound was classified as neither first inhibitor nor second inhibitor but a first-prime inhibitor for convenience. The pH of each polishing composition was adjusted to a value of 2.2, as measured using an ORION™ VERSA STAR PRO™ pH/ISE/conductivity/dissolved oxygen multiparameter benchtop meter. In particular, after adding the oxidizer, the pH was adjusted to 2.2. Then, when adding the first inhibitor, HNO₃ was also added to prevent the pH from drifting above 5. The pH was then adjusted to 2.2 before adding the second inhibitor. During addition of the second inhibitor, if present, HNO₃ was also added to prevent the pH from drifting above 5, after which the pH was again adjusted to 2.2, before adding the abrasive and the biocide (KATHON™, about 0.01 wt. %, relative to the total weight of the composition) and using HNO₃ and/or KOH to adjust the final pH to 2.2.

Each polishing composition (1-18) shown in Table 1 included 0.1 wt. % of unmodified colloidal silica particles having a primary average particle diameter of 12 nm and an average secondary particle size of 30 nm, with a polishing composition pH of 2.2

### Example 2

### Mo Removal Rate and Static Etch Rates for Mo Polishing Compositions

To test the polishing performance of polishing compositions according to the present disclosure in terms of Mo RR, Mo SER, and Mo RR-to-SER selectivity, polishing compositions were used to polish a Mo substrate prepared by depositing 200 nm Mo by PVD onto a Si wafer (DK Nano Tech) using a table top polisher operated using the following polishing composition:
Pad: FUJIBO OVP9500;
Conditioner: 3M nylon brush;
Down force: 1-2 psi;
Platen rotation: 150 rpm;
Head rotation: 13 rpm
Slurry flow rate: 30 mL/min;
Polishing time: 60 sec.

To assess the removal rates achieved by the polishing compositions, Mo film thickness before and after polishing was measured using a Resmap Resistivity Mapping System (Creative Design Engineering, Inc.).

To determine the Mo RR, the thickness of the Mo layer was measured before and after polishing, then divided by the polishing time. To measure the Mo SER, the thickness of the Mo layer was measured, followed by immersing the substrate in 300 mL of the polishing composition for 5 min at 50° C.

If the Mo RR and the Mo SER are mentioned herein, the conditions described in Examples can be adopted. That is, the Mo SER refers to a rate of etching of molybdenum (Mo) at 50° C.

Different types and concentrations of oxidizers, first inhibitors, and second inhibitors were used in the polishing compositions to determine Mo RR, Mo SER, and Mo RR/SER selectivity. The polishing performance is summarized in Table 1. (“MA”=maleic acid.)

TABLE 1
Effects of oxidizer, first inhibitor, and second inhibitor on Mo removal rate and static etch rate

| | | | | | | | | Mo | |
|---|---|---|---|---|---|---|---|---|---|
| | | Concen- | | Concen- | | Concen- | Mo | SER | |
| | | tration of | | tration of | | tration of | RR | 50° C. | Mo |
| | | oxidizer | Inhibitor 1/ | inhibitor 1 | Inhibitor | inhibitor 2 | (Å/ | (Å/ | RR/ |
| Slurry | Oxidizer | (wt. %) | inhibitor 1′ | (wt. %) | 2 | (wt. %) | min) | min) | SER |
| 1 | KIO₃ | 0.9 | — | — | — | — | 1580 | 1817 | 0.9 |
| 2 | KIO₃ | 0.9 | JEFFAMINE ® | 0.1 | JEFFAMINE ® | 0.025 | 1214 | 20 | 60.7 |
| | | | EDR-148 | | T-403 | | | | |
| 3 | KIO₃ | 0.9 | JEFFAMINE ® | 0.1 | — | — | 1220 | 411 | 3.0 |
| | | | EDR-148 | | | | | | |
| 4 | KIO₃ | 0.9 | JEFFAMINE ® | 0.1 | — | — | 1512 | 163 | 9.3 |
| | | | D-400 | | | | | | |
| 5 | KIO₃ | 0.9 | JEFFAMINE ® | 0.1 | — | — | 1206 | 196 | 6.2 |
| | | | D-230 | | | | | | |
| 6 | KIO₃ | 0.9 | JEFFAMINE ® | 0.1 | — | — | 1368 | 1382 | 1.0 |
| | | | ED-600 | | | | | | |
| 7 | KIO₃ | 0.9 | — | — | JEFFAMINE ® | 0.1 | 732 | 7 | 104.6 |
| | | | | | T-403 | | | | |
| 8 | KIO₃ | 0.9 | EPOMIN ™ | 0.01 | — | — | 50 | 8 | 6.25 |
| | | | SP-006 | | | | | | |
| 9 | MA/Fe(NO₃)₃/H₂O₂ | 0.05/0.04/1 | — | — | — | — | 1950 | 3866 | 0.5 |
| 10 | MA/Fe(NO₃)₃/H₂O₂ | 0.05/0.04/1 | JEFFAMINE ® | 0.1 | JEFFAMINE ® | 0.025 | 1196 | 2926 | 0.4 |
| | | | EDR-148 | | T-403 | | | | |
| 11 | MA/Fe(NO₃)₃/H₂O₂ | 0.05/0.04/1 | JEFFAMINE ® | 0.1 | — | — | 1184 | 3158 | 0.4 |
| | | | EDR-148 | | | | | | |
| 12 | MA/Fe(NO₃)₃/H₂O₂ | 0.05/0.04/1 | JEFFAMINE ® | 0.1 | — | — | 1230 | 2913 | 0.4 |
| | | | D-400 | | | | | | |
| 13 | MA/Fe(NO₃)₃/H₂O₂ | 0.9 | — | — | — | — | 1772 | 2320 | 0.8 |
| 14 | Periodic acid | 0.9 | JEFFAMINE ® | 0.1 | JEFFAMINE ® | 0.025 | 1694 | 232 | 7.3 |
| | (H₅IO₆) | | EDR-148 | | T-403 | | | | |
| 15 | Periodic acid | 0.9 | JEFFAMINE ® | 0.1 | — | — | 1612 | 2110 | 0.76 |
| | (H₅IO₆) | | EDR-148 | | | | | | |
| 16 | Periodic acid | 0.9 | JEFFAMINE ® | 0.1 | — | — | 1358 | 365 | 3.72 |
| | (H₅IO₆) | | D-400 | | | | | | |
| 17 | (NH₄)₂S₂O₈/H₂O₂ | 3/3 | JEFFAMINE ® | 0.1 | — | — | 698 | 545 | 1.28 |
| | | | EDR-148 | | | | | | |
| 18 | (NH₄)₂S₂O₈/H₂O₂ | 3/3 | JEFFAMINE ® | 0.1 | — | — | 714 | 596 | 1.20 |
| | | | D-400 | | | | | | |

As shown in Table 1, when a first inhibitor (e.g., a diamine, such as JEFFAMINE® EDR-148) and a second inhibitor (e.g., a triamine, such as JEFFAMINE® T-403) are used in combination, along with an oxidizer comprising a halogen oxoacid (e.g., periodic acid or KIO₃), the polishing compositions according to the present composition achieve a high Mo RR and a low Mo SER, thereby achieving a high Mo RR/SER selectivity suitable for polishing Mo substrates. Specifically, the present composition achieves:
i) a Mo SER of less than or equal to 250 Å/min and
ii) a Mo RR of greater than or equal to 1,600 Å/min, or a Mo RR of greater than or equal to 1,000 Å/min and a SER of greater than or equal to 10. The compositions of slurries 2 and 14 are preferable from the above-mentioned viewpoints. Among these, slurry 2 has a Mo RR of greater than or equal to 1200 Å/min, which is equivalent to those of slurries 4 to 6, but enables reducing the Mo SER by a factor of about 8 to about 140 as compared with those of slurries 4 to 6. Consequently, slurry 2 can achieve a Mo RR/SER selectivity of greater than 60, and is therefore preferred. While slurry 7, containing only triamine, enables reducing the Mo SER remarkably, the slurry also reduces the Mo RR markedly. Slurry 7 is not, therefore, preferred.

While certain embodiments have been illustrated and described, it should be understood that changes and modifications may be made therein in accordance with ordinary skill in the art without departing from the technology in its broader aspects as defined in the following claims.

The compositions and methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof. It is recognized that various modifications are possible within the scope of the disclosure claimed. Thus, it should be understood that although the present disclosure has been specifically disclosed by preferred embodiments and optional features, modification and variation of the disclosure embodied therein herein disclosed may be resorted to by those skilled in the art, and that such modifications and variations are considered to be within the scope of this disclosure.

The disclosure has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein. The present technology is not to be limited in terms of the particular embodiments described in this application, which are intended as single illustrations of individual aspects of the present technology. Many modifications and variations of this present technology can be made without departing from its spirit and scope, as will be apparent to those skilled in the art. Functionally equivalent methods and apparatuses within the scope of the present technology, in addition to those enumerated herein, will be apparent to those skilled in the art from the foregoing descriptions. Such modifications and variations are intended to fall within the scope of the present technology. It is to be understood that this present technology is not limited to particular methods, reagents, compounds compositions or biological systems, which can, of course, vary. It is also to be understood that the terminology used herein is for the purpose of describing particular embodiments only, and is not intended to be limiting.

One skilled in the art readily appreciates that the present disclosure is well adapted to carry out the objects and obtain the ends and advantages mentioned, as well as those inherent therein. Modifications therein and other uses will occur to those skilled in the art. These modifications are encompassed within the spirit of the disclosure and are defined by the scope of the claims, which set forth non-limiting embodiments of the disclosure.

In addition, where features or aspects of the disclosure are described in terms of Markush groups, those skilled in the art will recognize that the disclosure is also thereby described in terms of any individual member or subgroup of members of the Markush group.

All references, articles, publications, patents, patent publications, and patent applications cited herein are incorporated by reference in their entireties for all purposes. However, mention of any reference, article, publication, patent, patent publication, and patent application cited herein is not, and should not be taken as, an acknowledgment or any form of suggestion that they constitute valid prior art or form part of the common general knowledge in any country in the world.

Other embodiments are set forth in the following claims.

The present application is based on U.S. Provisional Patent Application No. 63/554,708, filed on Feb. 26, 2024, the disclosure of which is incorporated herein by reference in its entirety.

What is claimed is:

1. A polishing composition, comprising:
an abrasive;
an oxidizer containing halogen oxoacids or salts thereof;
a first inhibitor comprising a diamine; and
a second inhibitor comprising a triamine.

2. The polishing composition of claim 1, wherein the pH is from 1.5 to 5.

3. The polishing composition of claim 2, wherein the pH is less than 4.

4. The polishing composition of claim 1, wherein the diamine is represented by the formula:
H₂N-(AO)ₓ-A-NH₂
wherein A are each independently a divalent aliphatic group having 1 to 4 carbon atoms, and x is greater than or equal to 1 and less than or equal to 50.

5. The polishing composition of claim 4, wherein A is a methylene group or a propylene group.

6. The polishing composition of claim 1, wherein the triamine is represented by the formula:
C{—R}{—R¹(OA)ₓ-NH₂}{—R²(OA)_{y}-NH₂}{—R³(OA)_{z}-NH₂}
wherein A are each independently an alkylene group having 1 to 4 carbon atoms,
R is a hydrogen atom or an alkyl group having 1 to 4 carbon atoms,
R¹ to R³ are each independently an alkylene group having 1 to 4 carbon atoms,
x, y, and z are each independently 1 to 30, and
the sum of x, y, and z is 3 to 90.

7. The polishing composition of claim 6,
wherein A is a methylene group or a propylene group,
R is an alkyl group having 1 to 3 carbon atoms, and
R¹ to R³ are each independently an alkylene group having 1 to 3 carbon atoms.

8. The polishing composition of claim 1, wherein the oxidizer comprises iodic acid or a salt thereof.

9. The polishing composition of claim 1, wherein the first inhibitor has a molecular weight of 100 to 300, and the second inhibitor has a molecular weight of 300 to 500.

10. The polishing composition of claim 1, wherein a ratio of a weight of the diamine to a weight of the triamine is greater than or equal to 1.5.

11. The polishing composition of claim 1,
wherein the polishing composition achieves:
i) a MO static etch rate (SER) at 50° C. of less than or equal to 250 Å/min, and
ii) a Mo removal rate (Mo RR) of greater than or equal to 1,600 Å/min, or a Mo removal rate (Mo RR) of greater than or equal to 1,000 Å/min and a Mo RR/SER selectivity of greater than or equal to 10.
